(19) United States
(12) Patent Application Publication
(10) Pub. No.: US 2022/0284189 A1
(43) Pub. Date: Sep. 8, 2022

(54) SIMILARITY SCORE EVALUATION APPARATUS, SIMILARITY SCORE EVALUATION METHOD, AND PROGRAM

(71) Applicant: NIPPON TELEGRAPH AND TELEPHONE CORPORATION, Tokyo (JP)

(72) Inventors: Rina OKADA, Musashino-shi, Tokyo (JP); Satoshi HASEGAWA, Musashino-shi, Tokyo (JP)

(73) Assignee: NIPPON TELEGRAPH AND TELEPHONE CORPORATION, Tokyo (JP)

(21) Appl. No.: 17/631,503

(22) PCT Filed: Aug. 7, 2019
(86) PCT No.: PCT/JP2019/031215

§ 371 Date: Jan. 31, 2022

(51) Int. Cl. G06F 40/268; G06F 40/289

(52) U.S. Cl. CPC G06F 40/268; G06F 40/289

(57) ABSTRACT

Similarity score between character strings is evaluated in consideration of concept. A similarity score evaluation apparatus receives inputs of a first character string and a second character string and outputs a similarity score between the character strings. A term unification unit replaces words contained in the first character string and the second character string having the same concept and different representations so that the representations are identical, using the term unification data. A morphological analysis unit performs a morphological analysis of the first character string and the second character string. A concept deleting unit deletes a predetermined morpheme from a morphological analysis result of the first character string and a morphological analysis result of the second character string. A similarity score calculating unit obtains a number of morphemes included in both of a morphological analysis result of the first character string and a second character string as a similarity score.

### TECHNICAL FIELD

The present invention relates to a natural language processing technique, and more particularly to a technique for evaluating similarity score between character strings in consideration of concept.

### BACKGROUND ART

Methods for evaluating similarity score between two character strings include: (A) Number of matching characters; (B) Length of matching character strings; (C) Edit distance; and (D) Distance determined using distributed representations. It is also possible to combine these methods to evaluate the ultimate similarity score between two character strings.

The issues associated with four similarity scores respectively determined based on (A) to (D) listed above will be explained with reference to examples. In the following, { } (curly brackets) represent a set, with |{ }| indicating the number of elements in the set. For example, let us assume that there is a character string x, “NTT [symbol] [symbol] ”, and a character string set Y, {y₀=“NTT [symbol] ”, y₁=“ [symbol] [symbol] ”, y₂=“ [symbol] [symbol] (NTT)”, y₃=“ [symbol] [symbol] ”, y₄=“ [symbol] [symbol] ”}. Here, let us consider how a set of character strings Y*, which is a set of character strings in Y with the highest similarity score to x, i.e., which satisfies the following Equation (1), can be found using the methods (A) to (D), wherein yᵢ represents the i-th character string (0≤i≤|Y|−1 (=4)), and sim(x, yᵢ) represents the similarity score between x and yᵢ.

$$[ Math . 1 ]$$

$${Y}^{*} = {arg max}_{{y}_{i} ∈ Y} sim ( x , {y}_{i} ) \qquad ( 1 )$$

In the case of this example, x=“NTT [symbol] [symbol] ” (NTT advanced technology corporation) is conceptually closest to y₂=“ [symbol] [symbol] (NTT)” (advanced technology (NTT)), and therefore these two character strings should be determined as having the highest similarity score.

Similarity scores calculated based on “(A) Number of matching characters” are denoted as sim_{A}(⋅,⋅). Similarity scores calculated by the method (A) between x and each of y₀, . . . , y₄ are as follows.

sim_{A}(x, y₀)=|{‘N’, ‘T’, ‘T’}|=3

sim_{A}(x, y₁)=|{ [symbol] [symbol] [symbol] [symbol] [symbol] }|=14
sim_{A} (x, y₂)=|{ [symbol] [symbol] [symbol] [symbol] ‘N’, ‘T’, ‘T’}|=13
sim_{A}(x, y₃)=|{ [symbol] [symbol] [symbol] [symbol] }|=12
sim_{A}(x, y₄)=|{ [symbol] [symbol] }|=4

Therefore, we have Equation (2).

$$[ Math . 2 ]$$

$${Y}^{*} = {arg max}_{{y}_{i} ∈ Y} {sim}_{A} ( x , {y}_{i} ) = \{ {y}_{1} \} \qquad ( 2 )$$

As seen, when determined based on the number of characters, the calculated similarity scores are wrong in terms of concept since the orders of characters are not considered at all.

Similarity scores calculated based on “(B) Length of matching character strings” are denoted as sim_{B}(108 ,⋅). Similarity scores calculated by the method (B) between x and each of y₀, . . . , y₄ are as follows.

sim_{B}(x,y₀)=|‘NTT’|=3

sim_{B}(x,y₁)=|‘ [symbol] ’|=4

sim_{B}(x,y₂)=|‘ [symbol] [symbol] ’|10

sim_{B}(x,y₃)=|‘ [symbol] [symbol] ’|=12

sim_{B}(x,y₄)=|‘ [symbol] ’|=4

Therefore, we have Equation (3).

$$[ Math . 3 ]$$

$${Y}^{*} = {arg max}_{{y}_{i} ∈ Y} {sim}_{B} ( x , {y}_{i} ) = \{ {y}_{3} \} \qquad ( 3 )$$

As seen, when determined based on the length of character strings, the calculated similarity scores are wrong in terms of concept since the concepts of characters are not considered at all.

Similarity scores calculated based on “(C) Edit distance” are denoted as sim_{C}(⋅, ⋅). The edit distance is calculated from the number of operations (insertion, deletion, substitution) required to change a certain character string “a” to another character string “b” and the cost of each operation. The cost of each operation, in particular, can vary depending on the case. The calculation result of the edit distance also depends on the order of the operations. Here, therefore, examples of minimum edit distances (=Levenshtein distance) when all the costs of the operations are assumed to be the same will be checked. The smaller the “distance” value, the higher the similarity score. Thus, here, sim_{C}(⋅,⋅) is denoted simply as the inverse of the edit distance. Similarity scores calculated by the method (C) between x and each of y₀, . . . , y₄ are as follows.

sim_{C}(x,y₀)= 1/14

sim_{C}(x,y₁)=⅛

sim_{C}(x,y₂)= 1/10

sim_{C}(x,y₃)=⅕

sim_{C}(x,y₄)= 1/13

Therefore, we have Equation (4).

$$[ Math . 4 ]$$

$${Y}^{*} = {arg max}_{{y}_{i} ∈ Y} {sim}_{C} ( x , {y}_{i} ) = \{ {y}_{3} \} \qquad ( 4 )$$

In the case of edit distance, since the “NTT” at the head of y₁ and “NTT” near the end are different in position even though they represent the same concept, the operations include deletion of “NTT” at the head and insertion of “NTT” near the end. Such operations produce a large distance, as a result of which the calculated similarity score is wrong in terms of concept.

Similarity scores calculated based on “(D) Distance determined using distributed representations” are denoted as sim_{D}(⋅,⋅). Techniques such as word2vec (see, for example, NPL 1) and fastText (see, for example, NPL 2) are known as methods for evaluating distance using distributed representations. Features of character strings are calculated from a document or the like that contains each character string and the features (distributed representations) are retained in the form of vectors. To evaluate the distance (=similarity score) between two character strings, the distance is calculated using the L2 norm or cosine similarity score, which are known concepts, of the vectors of these two character strings. (D) is most focused on the conceptual similarity among (A) to (D).

### CITATION LIST

### Non Patent Literature

[NPL 1] Tomas Mikolov, Kai Chen, Greg S. Corrado, and Jeffrey Dean, “Efficient estimation of word representations in vector space”, a rXiv:1301.3781, 2013.
[NPL 2] Piotr Bojanowski, Edouard Grave, Armand Joulin, and Toma s Mikolov, “Enriching word vectors with subword information”, Transactions of the Association for Computational Linguistics, Vol. 5, pp. 135-146, 2017.

### SUMMARY OF THE INVENTION

### Technical Problem

However, in determining distance using distributed representations, when the data such as a document used for calculating distributed representations does not contain the target character string (or when the frequency of appearance is very low), the vector (=distributed representation) of that character string is not calculated. There may therefore be cases where, while there are vectors of x and y₀, there are no vectors of y₁, y₂, y₃, y₄. In this case, similarity score evaluation other than sim_{D}(x, y₀) is not possible. Namely, there are cases where similarity score cannot be calculated for all the character strings based on the distance determined using distributed representations.

In view of the technical issue described above, an object of this invention is to provide a method for evaluating similarity score between character strings in consideration of concept without using distributed representations.

### Means for Solving the Problem

To solve the issue described above, a similarity score evaluation apparatus in one aspect of the present invention includes a morphological analysis unit that performs a morphological analysis of a first character string and a second character string, and a similarity score calculating unit that obtains a number of morphemes included in both of a morphological analysis result of the first character string and a morphological analysis result of the second character string as a similarity score.

### Effects of the Invention

This invention can provide a method for evaluating similarity score between character strings in consideration of concept without using distributed representations.

### BRIEF DESCRIPTION OF DRAWINGS

FIG. 1 is a diagram illustrating an example of a functional configuration of a similarity score evaluation apparatus.

FIG. 2 is a diagram illustrating an example of processing steps of a similarity score evaluation method.

FIG. 3 is a diagram illustrating an example of a functional configuration of a computer.

### DESCRIPTION OF EMBODIMENTS

Hereinafter, one embodiment of this invention will be described in detail. Constituent units having the same functions in the drawings are given the same reference numerals to omit repetitive description.

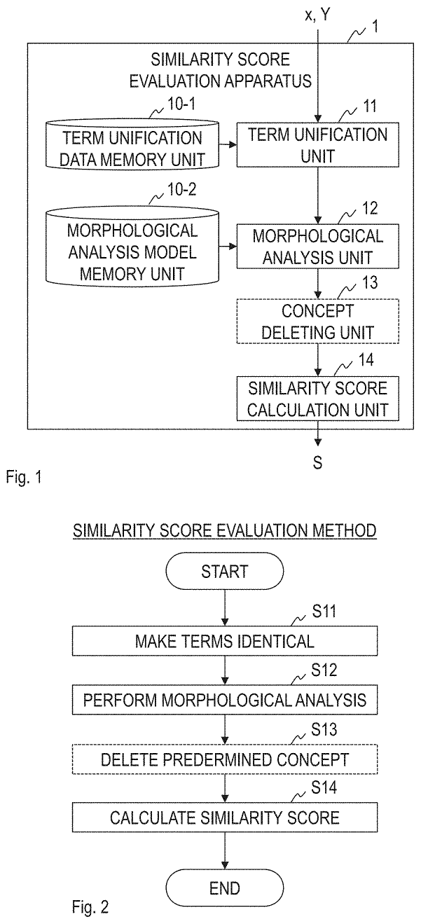

The similarity score evaluation apparatus 1 of the embodiment includes, as illustrated in FIG. 1, a term unification data memory unit 10-1, a morphological analysis model memory unit 10-2, a term unification unit 11, a morphological analysis unit 12, and a similarity score calculating unit 14. The similarity score evaluation apparatus 1 may further include a concept deleting unit 13. With this similarity score evaluation apparatus 1 performing each step of processing illustrated in FIG. 2, the similarity score evaluation method of the embodiment is realized.

The similarity score evaluation apparatus 1 is, for example, a special device configured by a known or dedicated computer including a central processing unit (CPU: Central Processing Unit), a main memory device (RAM: Random Access Memory) and so on, with a special program read therein. The similarity score evaluation apparatus 1 executes various steps of processing under the control of the central processing unit, for example. The data input to the similarity score evaluation apparatus 1 and the data obtained in various steps of processing are stored in the main memory device, for example. The data stored in the main memory device is read out to the central processing unit as required and used for other processing. At least some parts of various processing units of the similarity score evaluation apparatus 1 may be configured by hardware such as integrated circuits. Various memory units of the similarity score evaluation apparatus 1 may be configured by the main memory device such as RAM (Random Access Memory), for example, or by an auxiliary memory device such as a hard disk or an optical disc, or a semiconductor memory device such as a flash memory, or by middleware such as relational database or key-value store.

The similarity score evaluation apparatus 1 receives inputs of a character string x and a character string set Y={y₀, . . . , y_{|Y|-1}}, and outputs a set of similarity scores S={simₚᵣₒₚ(x, y₀), . . . , simₚᵣₒₚ(x, y_{|Y|-1})} between the character string x and the character string set Y, where simₚᵣₒₚ(x, y₁) represents the similarity score between the character string x and the character string yᵢ∈Y.

The term unification data memory unit 10-1 stores term unification data Z={z₀, . . . , z_{|Z|-1}}. Here, zᵢ∈Z is a set of character strings having the same concept but different representations, and |Z| is the number of concepts in {x} U Y.

The morphological analysis model memory unit 10-2 stores morphological analysis models m. The morphological analysis models m are prepared in advance by utilizing a morphological analyzer such as, for example, MeCab (see Reference Literature 1) or JUMAN (see Reference Literature 2).
[Reference Literature 1] “MeCab: Yet Another Part-of-Speech and Morphological Analyzer”, [online search on Jul. 29, 2019]<Internet URL: http://taku910.github.io/mecab/>
[Reference Literature 2] “JUMAN-KUROHASHI-KAWAHARA LAB”, [online search on Jul. 29, 2019]<:Internet URL: http://nlp.ist.i.kyoto-u.ac.jp/index.php?JUMAN>

Hereinafter a similarity score evaluation method executed by the similarity score evaluation apparatus 1 of the embodiment will be described with reference to FIG. 2.

At step S11, if the character string x and all the character strings yᵢ∈Y include terms having different representations but sharing the same concept, the term unification unit 11 makes the terms identical, using the term unification data stored in the term unification data memory unit 10-1, and generates a character string x′ and character strings y′ᵢ∈Y′ after the terms have been made identical. Y and Y′ are ordered sets (=lists), and y′ᵢ∈Y′ stores character strings after the terms in y₁∈Y have been made identical. The term unification unit 11 outputs the character string x′ and character string set Y′ after the terms have been made identical to the morphological analysis unit 12.

The processing details of the term unification unit 11 are illustrated below. Here, z_{(i, 0)} represents the 0-th element of zᵢ.

Algorithm 1: Term unification unit

| Input: Character string x, character string set Y, | |
|---|---|
| term unification data Z | |
| Output: x′ and Y′ after terms have been made identical | |
| 1: | for i ∈ [0, \| Z \| −1] do |
| 2: | if x ∈ zᵢ then |
| 3: | x′ ← z _{(i, 0)} |
| 4: | end if |
| 5: | end for |
| 6: | create Y′ having element of the same size as |
| | Y (where y′ ᵢ ∈ Y′ is empty when ∀i ∈ [0, \| Y′ \| −1] ) |
| 7: | for i ∈ [0, \| Y \| −1] do |
| 8: | j ∈ [0, \| Z \| −1] do |
| 9: | if yᵢ ∈ zⱼ then |
| 10: | y′ ᵢ ← z _{(i, 0)} |
| 11: | end if |
| 12: | end for |
| 13: | end for |
| 14: | return x′ , Y′ |

For example, assuming that the term unification data zᵢ is zᵢ={“NTT”, “ [symbol] [symbol] ” (Nippon Telegraph and Telephone Corporation)}, if x or yᵢ E Y includes the character string “ [symbol] [symbol] ”, this character string “ [symbol] [symbol] ” is replaced with the character string z_{i, 0)}=“NTT”.

At step S12, the morphological analysis unit 12 decomposes the character string x′ and all the character strings y′ᵢ∈Y′ into morphemes, using a morphological analysis model m stored in the morphological analysis model memory unit 10-2, and generates a morphological analysis result x″ of the character string x′ and a morphological analysis result y″ᵢ∈Y″ of the character string y′ᵢ∈Y′. Y′ and Y″ are ordered sets (=lists), and y″ᵢ ∈Y″ stores the results of morphological analysis of y′ᵢ ∈Y′. The morphological analysis unit 12 outputs the morphological analysis result x″ and the morphological analysis result set Y″ to the similarity score calculating unit 14.

The processing details of the morphological analysis unit 12 are illustrated below. Here, the morphological analysis model is represented as function “m: character string-character string set”.

Algorithm 2: Morphological analysis unit

| Input: Character string x′ and character string | |
|---|---|
| set Y′ after the terms have been made identical, | |
| morphological analysis model m | |
| Output: x″, Y″ decomposed into morphemes | |
| 1: | x″ = m (x′ ) |
| 2: | create Y″ having element of same size as |
| | Y′ (where y″ᵢ ∈ Y″ is empty when ∀i ∈ [0, \| Y″ \| −1] ) |
| 3: | for i ∈ [0, \| Y′ \| −1] do |
| 4: | y″ᵢ ← m (y′ᵢ) |
| 5: | end for |
| 6: | return x″, Y″ |

For example, if the character string x is “NTT [symbol] [symbol] ” (NTT advanced technology corporation), then m(x), the set of morphemes (≈ concepts) of x, will be m(x)={“NTT”, “ [symbol] ” (advanced), “ [symbol] ” (technology), “ [symbol] ” (corporation)}. How the string is broken down into morphemes depends on the algorithm of the morphological analyzer or the dataset used for calculating the morphological analysis model.

At step S14, the similarity score calculating unit 14 calculates similarity score simₚᵣₒₚ(x, yᵢ)∈S for all the sets of the morphological analysis result x″ and the morphological analysis results y″ᵢ∈Y″. The similarity score calculating unit 14 outputs a similarity score set S as the output of the similarity score evaluation apparatus 1.

The processing details of the similarity score calculating unit 14 are illustrated below. Here, x″ᵢ represents the i-th element of x″, and y″_{(i, j)} represents the j-th element of y″ᵢ.

Algorithm 3: Similiarity score calculating unit

| Input: Character string x, character string set Y, x″, Y″ | |
|---|---|
| decomposed into morphemes | |
| Output: Similarity score vector S with elements each | |
| corresponding to elements of Y | |
| 1: | create set S having element corresponding to element |
| | of Y (where initial value of sᵢ ∈ S (i ∈ [0, \| S \|−1] ) is 0) |
| 2: | for i ∈ [0, \| x″ \| −1] do |
| 3: | for j ∈ [0, \| Y″ \|−1] do |
| 4: | for k ∈ [0, \| y″ⱼ \| −1] do |
| 5: | if x″ᵢ = y″_{(j, k)} then |
| 6: | sⱼ = sⱼ + 1 |
| 7: | end if |
| 8: | end for |
| 9: | end for |
| 10: | end for |
| 11: | return S |

For example, when x″={“NTT”, “ [symbol] ” (advanced), “ [symbol] ” (technology), “ [symbol] ” (corporation)}, and y″₀={“NTT”, “ [symbol] ” (data)}, “NTT” is the only one of the elements of x″ that y″₀ has in common. Therefore, in this case, x″ and y″₀ have a similarity score of s₀=1.

### Variation Example

For example, when the concept of a character string to be evaluated for similarity score is predictable (e.g., when it is known that it is a corporate name, as in the example above), measuring the similarity score using a word that represents that concept (e.g., “corporation” as in the example above) is ineffectual, or counterproductive. When the concept is already known, which may provide an ineffectual, or counterproductive result, such concept may as well be deleted from the morphological analysis result.

In this case, the similarity score evaluation apparatus 1 further includes a concept deleting unit 13. The concept deleting unit 13 deletes a predetermined concept (=morpheme) from the morphological analysis result x″ and the morphological analysis results y″ᵢ∈Y″ output by the morphological analysis unit 12 before the results are output to the similarity score calculating unit 14.

### Concrete Example

Using the example above, a specific flow of processing will be illustrated.

The character string x input to the similarity score evaluation apparatus 1 is “NTT [symbol] [symbol] ” (NTT advanced technology corporation), and the character string set Y is {y₀=“NTT [symbol] ” (NTT data), y₁=“ [symbol] [symbol] ” (baatekujisudononro corporation), y₂=“ [symbol] [symbol] (NTT)” (advanced technology (NTT)), y₃=“ [symbol] [symbol] ” (bansu-technology corporation), y₄=“ [symbol] [symbol] ” (Nippon Telegraph and Telephone West Corporation)}.

The processing by the term unification unit 11 converts the character string x into x′=“NTT [symbol] [symbol] ” (NTT advanced technology corporation), and the character string set Y into Y′={y′₀=“NTT [symbol] ” (NTT data), y′₁=“ [symbol] [symbol] ” (baatekujisudononro corporation), y′₂=“ [symbol] [symbol] (NTT)” (advanced technology (NTT)), y′₃=“ [symbol] [symbol] ” (bansu-technology corporation), y′₄=“ [symbol] NTT” (NTT West)}.

The processing by the morphological analysis unit 12 converts the character string x′ into x″={“NTT”, “ [symbol] ” (advanced), “ [symbol] ” (technology), “ [symbol] ” (corporation)}, and the character string set Y′into Y″={y″₀={“NTT”, “ [symbol] ” (data)}, y″₁={“ [symbol] [symbol] ” (baatekujisudononro), “ [symbol] ” (corporation)}, y″₂={“ [symbol] ” (advanced), “ [symbol] ” (technology), “(”, “NTT”, “)”}, y″₃={“ [symbol] ” (bansu-technology), “ [symbol] ” (corporation)}, y″₄={“ [symbol] ” (west), “NTT” }.

The processing by the similarity score calculating unit 13 converts the similarity scores between x and each of y₁∈Y into the following:

simₚᵣₒₚ(x,y₀)=1

simₚᵣₒₚ(x,y₁)=1

simₚᵣₒₚ(x,y₂)=3

simₚᵣₒₚ(x,y₃)=1

simₚᵣₒₚ(x, y₄)=1

As shown above, x and y₂ are evaluated to have the highest similarity score, and it can be said that similarity score evaluation between character strings was successfully performed in consideration of concept without using distributed representations.

### Application Example

The concrete example described above is an extreme case given for easy understanding of the processing steps. In this section one example will be shown where the effect of invention becomes evident when applied to an actual service. Let us assume that Organization A wishes to classify the products it handles into categories, and that there is another Organization B that already has the practice of classifying the products it handles into categories. Let us consider a situation where Organization A classifies the products it handles into categories using the classification method of Organization B as a guide.

Data of the products handled by Organization A is represented as x₁, . . . , x₃ in Table 1, where “∘∘∘”, “ΔΔΔ”, “♦♦♦”, and “⋄⋄⋄” represent proper nouns such as makers' names.

TABLE 1

| No. | Product Name |
|---|---|
| X₁ | ○○○ free gift package, ○○○ clock, ○○○ bracket clock, alarm |
| | clock, radio clock, ○○○ bracket clock, ○○○ alarm clock, |
| | ○○○ radio clock, digital, wood-grain pattern, calendar, |
| | thermometer, hygrometer, fashionable [gift] |
| X₂ | rack, steel rack, EL series, system wire shelf, metal |
| | shelf, made by ΔΔΔ [free shipping] |
| X₃ | with casters, closet storage rack (width 38), closet |
| | storage rack, closet, wagon, storage box, gap-filling |
| | storage, storage furniture, ♦♦♦, ⋄⋄⋄ [free shipping] |

Data of classified products owned by Organization B is represented as Y₁₁, . . . , Y₁₆, Y₂₁, . . . , Y₂₅, Y₃₁, . . . , Y₃₆ in Table 2.

TABLE 2

| No. | Category Name/Product Name |
|---|---|
| Y₁₁ | all categories |
| Y₁₂ | home & kitchen |
| Y₁₃ | furniture |
| Y₁₄ | storage furniture |
| Y₁₅ | metal rack |
| Y₁₆ | ΔΔΔ open shelf/rack, racks only, |
| | 5-tiered, height 180 cm |
| Y₂₁ | all categories |
| Y₂₂ | home & kitchen |
| Y₂₃ | interior |
| Y₂₄ | bracket clock/wall hung clock |
| Y₂₅ | ○○○ clock, bracket clock, 01: white pearl, |
| | body size: 8.5 × 14.8 × 5.3 cm, radio, |
| | digital, calendar, level of comfort, |
| | temperature, humidity, display |
| Y₃₁ | all categories |
| Y₃₂ | home & kitchen |
| Y₃₃ | furniture |
| Y₃₄ | dining/kitchen furniture |
| Y₃₅ | storage wagon |
| Y₃₆ | ♦♦♦ (⋄⋄⋄) closet storage rack, with casters, |
| | width 20, natural maple/ivory |

The results of calculations of similarity scores according to the present invention between data of Organization A shown in Table 1 as a character string x and data of Organization B shown in Table 2 as a character string set Y are as follows. Here, sim(⋅, ⋅) represents a similarity score calculated according to the present invention, and the character strings inside the curly brackets are morphemes present in both of the two character strings.

$$sim ( {x}_{1} , {Y}_{11} ) = \vert \{ \} \vert = 0 \\ sim ( {x}_{1} , {Y}_{12} ) = \vert \{ \} \vert = 0 \\ sim ( {x}_{1} , {Y}_{13} ) = \vert \{ \} \vert = 0 \\ … \\ sim ( {x}_{3} , {Y}_{34} ) = \vert \{ “ furniture ” \} \vert = 1 \\ sim ( {x}_{3} , {Y}_{35} ) = \vert \{ “ storage ” , “ wagon ” \} \vert = 2$$

$$sim ( {x}_{3} , {Y}_{36} ) = \vert \{ “ ◆◆◆ ” , “ ◇◇◇ ” , closet ” , storage ” , rack ” , “ caster ” , “ with ” , “ width ” \} \vert = 8$$

Table 3 shows the results after character strings in Y of pairs of character strings x and character strings in Y having a high similarity score have been replaced with character strings in x. For example, products under x₃ handled by Organization A have a high similarity score to products under Y₃₆ handled by Organization B. Therefore, replacing Y₃₆ with x₃ allowed categories Y₃₁, . . . , Y₃₅ to be associated with x₃. Thus Organization A was able to correctly classify the products it handles into categories using the classification method of Organization B as a guide.

TABLE 3

| No. | Category Name/Product Name |
|---|---|
| Y₁₁ | all categories |
| Y₁₂ | home & kitchen |
| Y₁₃ | furniture |
| Y₁₄ | storage furniture |
| Y₁₅ | metal rack |
| Y₁₆ | rack, steel rack, EL series, system wire shelf, |
| | metal shelf, made by ΔΔΔ [free shipping] |
| Y₂₁ | all categories |
| Y₂₂ | home & kitchen |
| Y₂₃ | interior |
| Y₂₄ | bracket clock/wall hung clock |
| Y₂₅ | ○○○ free gift package, ○○○ clock, ○○○ |
| | bracket clock, alarm clock, radio clock, ○○○ |
| | bracket clock ○○○ alarm, clock, ○○○ radio |
| | clock, digital, wood-grain pattern, calendar, |
| | thermometer, hygrometer, fashionable [gift] |
| Y₃₁ | all categories |
| Y₃₂ | home & kitchen |
| Y₃₃ | furniture |
| Y₃₄ | dining/kitchen furniture |
| Y₃₅ | storage wagon |
| Y₃₆ | with casters, closet storage rack (width 38), |
| | closet storage rack, closet, wagon, storage |
| | box, gap-filling storage, storage |
| | furniture, ♦♦♦, ⋄⋄⋄ [free shipping] |

[Point of the Invention]

Conventional methods of evaluating similarity score between character strings did not allow evaluation in consideration of concept without using distributed representations. There are also cases where distributed representations of all the character strings to be evaluated for similarity score cannot be calculated when the frequency of appearance is not high such as proper nouns, in particular. This made similarity score evaluation in consideration of concept without using distributed representations a challenge. The present invention enables calculation of similarity score from morphological analysis results, which in turn makes possible to evaluate similarity score in consideration of concept without using distributed representations. Since the order of morphemes of proper nouns, in particular, often bears no meaning, similarity score is configured by focusing on the frequency of appearance, so that the similarity score can be evaluated correctly.

While the embodiment of this invention has been described above, it should be understood that specific configurations are not limited to those of the embodiment and any design changes or the like made without departing from the scope of this invention shall be included in this invention. Various processing steps described above in the embodiment may not only be executed in chronological order in accordance with the description, but also be executed in parallel or individually in accordance with the processing capacity of the device executing the processing, or in accordance with necessity.

[Program and Recording Medium]

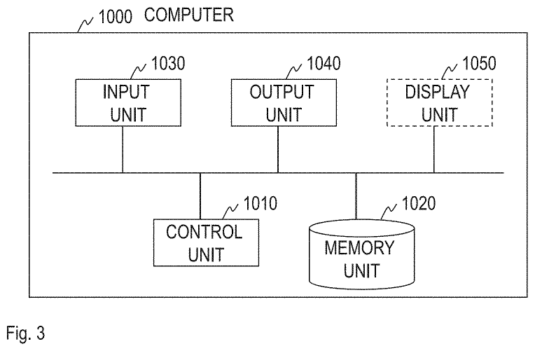

When the various processing functions of each of the devices described in the embodiment above are realized by a computer, the processing contents of the function each device should have are described by a program. With this program read into a memory unit 1020 of a computer illustrated in FIG. 3 and with a control unit 1010, an input unit 1030, and an output unit 1040 being operated, the various processing functions of each of the devices described above are realized on the computer.

The program that describes the processing contents may be recorded on a computer-readable recording medium. Any computer-readable recording medium may be used, such as, for example, a magnetic recording device, an optical disc, a magneto-optical recording medium, a semiconductor memory, and so on.

This program may be distributed by selling, transferring, leasing, etc., a portable recording medium such as a DVD, CD-ROM and the like on which this program is recorded, for example. Moreover, this program may be distributed by storing the program in a memory device of a server computer, and by forwarding this program from the server computer to another computer via a network.

A computer that executes such a program may, for example, first temporarily store the program recorded on a portable recording medium or the program forwarded from a server computer, in a memory device of its own. In executing the processing, this computer reads out the program stored in its own memory device, and executes the processing in accordance with the read-out program. Moreover, in another embodiment, the computer may read out this program directly from a portable recording medium and execute the processing in accordance with the program. Further, every time a program is forwarded from a server computer to this computer, the processing in accordance with the received program may be executed consecutively. In an alternative configuration, instead of forwarding the program from a server computer to this computer, the processing described above may be executed by a service known as ASP (Application Service Provider) that realizes processing functions only through instruction of execution and acquisition of results. It should be understood that the program in this embodiment includes information to be provided for the processing by an electronic calculator based on the program (such as data having a characteristic to define processing of a computer, though not direct instructions to the computer).

Note, instead of configuring the device by executing a predetermined program on a computer as in this embodiment, at least some of these processing contents may be realized by hardware.

1. A similarity score evaluation apparatus, comprising:
a morphological analysis circuit configured to perform a morphological analysis of a first character string and a second character string; and
a similarity score calculating circuit configured to obtain a number of morphemes included in both of a morphological analysis result of the first character string and a morphological analysis result of the second character string as a similarity score.

2. The similarity score evaluation apparatus according to claim 1, further comprising
a memory circuit configured to store term unification data including a set of a plurality of words having an identical concept and different representations, and
a term unification circuit configured to replace words contained in the first character string and the second character string having a same concept and different representations so that the representations are identical, using the term unification data.

3. The similarity score evaluation apparatus according to claim 1, further comprising a concept deleting circuit configured to delete a predetermined morpheme from a morphological analysis result of the first character string and a morphological analysis result of the second character string.

4. A similarity score evaluation method, comprising:
a step wherein a morphological analysis circuit performs a morphological analysis of a first character string and a second character string; and
a step wherein a similarity score calculating circuit obtains a number of morphemes included in both of a morphological analysis result of the first character string and a morphological analysis result of the second character string as a similarity score.

5. A computer-readable storage medium storing a program causing a computer to function as the similarity score evaluation apparatus according to claim 1.

6. The similarity score evaluation apparatus according to claim 2, further comprising a concept deleting circuit configured to delete a predetermined morpheme from a morphological analysis result of the first character string and a morphological analysis result of the second character string.
